(19) United States
(12) Patent Application Publication
(10) Pub. No.: US 2017/0101268 A1
(43) Pub. Date: Apr. 13, 2017

(54) Sorting Device For Piece Goods

(71) Applicant: Siemens Aktiengesellschaft, Muenchen (DE)

(72) Inventors: Peter BERDELLE-HILGE, Konstanz (DE); Dieter HOESCH, Konstanz (DE)

(21) Appl. No.: 15/129,130

(22) PCT Filed: Mar. 12, 2015
(86) PCT No.: PCT/EP2015/055141

§ 371 Date: Sep. 26, 2016

(30) Foreign Application Priority Data
Mar. 31, 2014 (DE) 10 2014 2060 16.8

(51) Int. Cl. B65G 17/34; B65G 47/96; B65G 39/20

(52) U.S. Cl. CPC B65G 17/345; B65G 39/20; B65G 47/96; B65G 2207/18

(57) ABSTRACT

A sorting device for piece goods includes a plurality of sorting cart elements each having at least one sorting element for receiving and dispensing the piece goods. In order to reduce the costs for the sorting device, the sorting device has at least one connecting cart element, which is free of sorting elements. The sorting cart elements and the at least one connecting cart element form a closed chain.

The invention relates to a sorting device for piece goods with a plurality of sorting cart elements, which each have at least one sorting element for receiving and dispensing the piece goods.

Sorting devices of the above kind are known from the prior art and are used for example for sorting parcels, items of baggage and other piece goods. In such devices the piece goods are first placed in a feeder area on the sorting elements of the sorting cart elements and are subsequently transported in accordance with a sorting destination of the piece goods to corresponding sorting outputs of the sorting device. At the sorting outputs the corresponding piece goods item is dispensed from the sorting element on which it has been transported. This can be done for example by the activation of a transverse conveyor belt or by the tipping of a tilt tray. An example of a sorting device of the said type is described in EP 1220719 B1.

The known sorting devices are very effective and tailored to specific customer requirements, but are also costly. The underlying idea of the invention is therefore to provide a sorting device of the type stated at the outset, which is especially cost-effective and at the same time is able to be tailored flexibly to changing customer requirements.

This object is achieved in accordance with the invention by the sorting device having at least one connecting cart element that is designed to be free of sorting elements, wherein the sorting cart elements and the at least one connecting cart element form a closed chain.

The inventive solution has the advantage that the at least one connecting cart element can be manufactured at low cost because it does away with the costly sorting element. Furthermore the throughput of the sorting device can be tailored by the use of the connecting cart element.

The invention can be developed by advantageous embodiments, which are described below.

Thus the connecting cart element and the sorting cart elements can each have a chassis, wherein the chassis are embodied the same. This has the advantage that the same construction of the chassis can be used for both the connecting cart elements and the sorting cart elements and synergy effects can thereby be utilized. Furthermore a connecting cart element can easily be converted to a sorting cart element if necessary. The chassis does not have to be exchanged for this. This has advantages when an existing system is to be upgraded for a higher throughput.

To minimize a potential danger that can arise for example by areas of the connecting cart element open to the top, the connecting cart element can have at least one cover which covers the top of the connecting cart element. So that no offset arises transverse to the direction of transport of the sorting device between the sorting cart elements and the at least one connecting cart element, the width of the cover can be equal to the width of the sorting cart elements. Furthermore the cover can have a surface and the sorting elements can have receiving surfaces for receiving the piece goods, wherein the receiving surfaces and the surface essentially run in one and the same receiving plane. Furthermore the cover and the sorting elements can be arranged so that their upper edges are at the same height. This has the advantage in each case that height differences between the connecting cart element and the sorting cart elements are avoided. The height differences can conceal a potential hazard and piece goods can catch on one another. Furthermore an optically uniform circulation of the sorting device carts can be achieved by the cover on the connecting cart element.

In an advantageous embodiment the sorting elements can each have at least one transverse conveyor belt or a tilt tray. Transverse conveyor belts or tilt trays and their respective power supplies and control elements that are necessary on the sorting cart element, although they are very effective, are also relatively costly. The cost benefit of the invention is therefore especially high for this type of sorting elements.

In order to give a greater reduction in manufacturing costs and tailor the throughput, the sorting device can have a number of connecting cart elements. In such cases the connecting cart elements and the sorting cart elements can be arranged alternately in the closed chain. The advantage of this is that the spacing between the sorting cart elements on the overall sorting device is enlarged evenly and through this a lower throughput at the feeder facilities or the sorting outputs is possible. This can reduce the complexity and the costs of the feeder facilities and the sorting outputs.

In an advantageous development the connecting cart elements and the sorting cart elements can each have just two wheels connected to one another via an axle, which can be arranged on a track of the sorting device. Since only one axle per connecting cart element and sorting cart element is needed, the manufacturing costs can be further reduced.

The inventive sorting device is described below on the basis of a form of exemplary embodiment in the enclosed figures, in which:

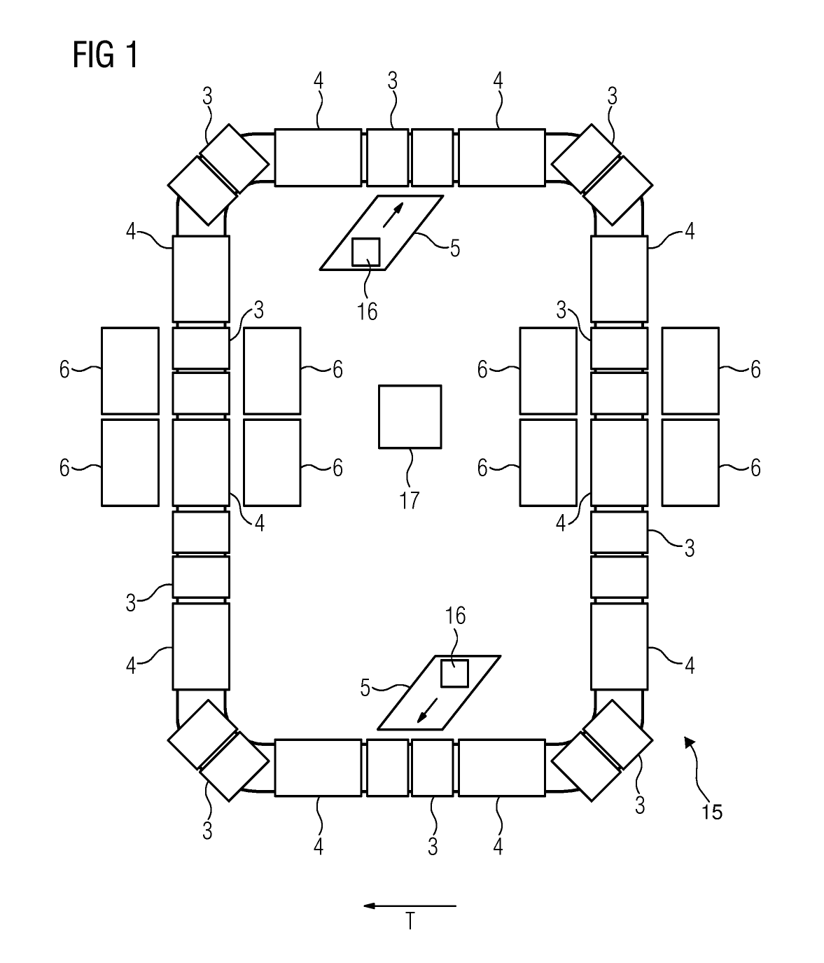

FIG. 1 shows a schematic diagram of a form of exemplary embodiment of the inventive sorting device in an overhead view;

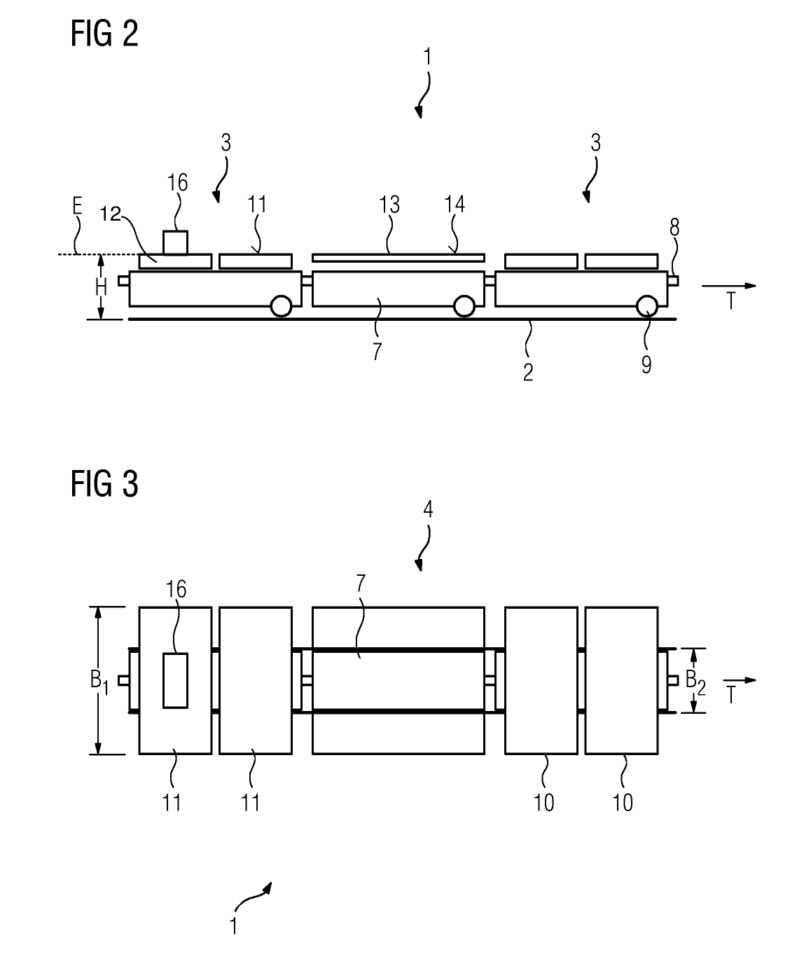

FIG. 2 shows a schematic diagram of a detail of the sorting device from FIG. 1 in a view from the side;

FIG. 3 shows a schematic diagram of the detail from FIG. 2 in an overhead view.

The inventive sorting device is described below with reference to FIGS. 1-3. The sorting device 1 in the form of exemplary embodiment depicted in FIGS. 1-3 comprises a track 2, a plurality of sorting cart elements 3, a plurality of connecting cart elements 4, two feeder stations 5 and a plurality of sorting outputs 6.

The track 2 of the sorting device 1 is arranged in a known way on the floor, on supports or on another foundation of a parcel sorting center or a baggage sorting center of an airport for example. The track 2 is a closed circuit and, when viewed from above, can take the form of a rectangle, circle, oval, of an ellipse, serpentine or similar. The surface of the track 2 is essentially aligned horizontally. The sorting cart elements 3 and the connecting cart elements 4, which form a closed chain 15, are arranged on the track 2.

The track 2 comprises a drive means (not shown), with which the sorting cart elements 3 and the connecting cart elements 4 can be moved together in a direction of transport T on the track 2. The track 2 is embodied here as a rail system on which the cart elements 3, 4 are guided in captive mode. The drive device can for example be a motor drive unit with a friction wheel that imparts movements to the sorting cart elements 3 and the connecting cart elements 4 or stops them. As an alternative the drive device can also be embodied as a non-contact drive system, e.g. as a magnetic pole wheel that drives struts arranged on the sorting cart elements 3 and/or the connecting cart elements 4 in a non-contact manner. Furthermore a motor with a toothed wheel is also conceivable as a drive device, which drives a chain connected to the sorting cart elements 3 and/or the connecting cart elements 4. Such drive devices are known from the prior art.

The sorting cart elements 3 have a chassis 7 that has a coupling 8 and two wheels 9 connected via an axle not shown in the diagram. The wheels 9 are arranged outside the center of the chassis 7 on the front end in the direction of transport T. Attached to the chassis 7 are two sorting elements 10 arranged behind one another in the direction of transport T. The sorting elements 10 have a width B1 transverse to the direction of transport T that is greater than the width B2 of the track 2 and of the chassis 7. The sorting elements 7 are arranged so that they project equally to both sides above the chassis 7. As an alternative B1 can also be approximately equal to B2, which, especially with heavy goods, results in the loads being well supported.

The sorting elements 10 each have a receiving surface 11 on the top surface, which runs in a receiving plane E. The receiving plane E, in the form of embodiment shown, is essentially aligned horizontally. The receiving surfaces 11 of the sorting elements 10 are arranged at a height H above the track 2. Each sorting element 10 has a transverse conveyor belt 12, known as a crossbelt. Tilt trays or similar can also be used as an alternative. The sorting elements 10 further each comprise a drive for the transverse conveyor belt 12, electronics, power supply and the like (not shown in each case). In the form of exemplary embodiment in FIGS. 1-3 a connecting cart element 4 is arranged between two sorting cart elements 3 in each case. The sorting cart elements 3 and the connecting cart elements 4 are connected to each other by the couplings 8. The couplings are designed to be rigid in a vertical direction so that a connecting cart element 4 or sorting cart element 3, each of which has only one axle, can be supported on the next connected connecting cart element 4 or sorting cart element 3.

The connecting cart elements 4 each have a chassis 7 that is identical to the chassis 7 of the sorting cart elements 3 described above. A cover 13 is attached to the chassis 7 of the connecting cart element 4 in each case. The connecting cart elements 4 do not have any sorting elements 10. The cover 13 is arranged so that its surface 14 runs essentially horizontally. The surface 14 of the cover 13 is arranged at approximately the same height H as the sorting elements 10 of the sorting cart elements 3. The width B1 of the cover 13 is equal to the width B1 of the sorting elements 10. The surface 14 runs like the surfaces of the sorting elements 10 at the same receiving level E. The sorting cart elements 3 and the connecting cart elements 4 are connected to one another via the coupling 8 of the chassis 7. In the closed chain 15 that is formed by the sorting cart elements 3 and the connecting cart elements 4, the sorting cart elements 3 and the connecting cart elements 4 are arranged alternately.

The feeder stations 5 are arranged at an angle to the track 2 and are equipped in the known way with a conveyor belt (not shown) moving at an oblique angle in relation to the direction of transport T. In the form of exemplary embodiment in FIG. 1 two feeder stations 5 essentially lying opposite one another are provided. However just one feeder station 5 can also be used.

The sorting outputs 6 are each arranged lying opposite one another next to the track 2. The sorting outputs 6 are embodied in a known way as chutes for example.

The sorting device 1 further comprises a controller 17, which is connected in terms of signaling technology to the drive of the track 2 and to the sorting elements 10.

The sorting of piece goods 16 with the inventive sorting device 1 is described below.

Piece goods 16 to be sorted, for example parcels or items of baggage, are made available at the feeder stations 5.

The respective feeder station 5 is activated by the controller 17, so that an item of piece goods 16 is fed onto a sorting cart element 3 at the right moment. In this case the respective feeder station 5 moves the item of piece goods 16 in the direction of the track 2. Furthermore the transverse conveyor belt 12 of the sorting cart element 3 is moved at the appropriate speed, which is matched to the speed of the conveyor belt of the feeder station 5. When the item of piece goods 16 is located on the transverse conveyor belt 12 of the sorting cart element 3, the transverse conveyor belt 12 is braked and stopped, so that the item of piece goods 16 can be transported in the middle onto the transverse conveyor belt 12. The chain 15 of sorting cart elements 3 and connecting cart elements 4 is driven continuously at the same speed in the direction of transport T. Thus a circuit of the sorting cart elements 3 and connecting cart elements 4 is produced on the endless track 2. The piece goods to be sorted are transported to an intended sorting output 6. At the right moment the transverse conveyor belt 12 of the sorting cart element 3 is activated by the controller 17 and is set in motion transverse to the direction of transport T. The piece goods are thus dispensed at one of the sorting outputs 6.

Through the use of the connecting cart elements 4 the throughput of piece goods that can be sorted per unit of time by the sorting device 1 can be adapted to the local requirements of the operator. Since the manufacturing costs of the connecting cart elements 4 are significantly lower than the manufacturing costs of the sorting cart elements 3, the costs for the sorting device 1 can be reduced by the use of the connecting cart elements 4. Since the connecting cart elements 4 have the same chassis 7 as the sorting cart elements 3, the connecting cart elements 4 can easily be converted at a later date into sorting cart elements 3. To do this it is merely necessary to remove the cover 13 and retrofit the sorting elements 10. Subsequently the converted connecting cart elements 4 that are now sorting cart elements 3 merely have to be activated in the controller 17 or configured in.

Instead of an alternating arrangement of sorting cart elements 3 and connecting cart elements 4, other arrangements are naturally also possible. For example a plurality of connecting cart elements 4 can be arranged between two sorting cart elements 3 in order to further reduce manufacturing costs. Conversely the throughput of the sorting device 1 can also be increased if fewer connecting cart elements 4 than sorting cart elements 3 are used in the chain 15 of cart elements 3, 4. Throughput can also be increased by the use of two feeder stations 5, between which, seen in the direction of transport T, the sorting outputs 6 are arranged, as in FIGS. 1 to 3.

The inventive sorting system 1 can be used especially well when the throughput needed is low, but the length of the track 2 is fixed at a relatively great length, e.g. by the number of sorting outputs 6 needed. The number of cart elements 3, 4 needed is predetermined by the length of the track 2. If an unnecessarily large throughput would result from the exclusive use of sorting cart elements 3, the system can be adapted especially well by the invention.

1-10. (canceled)

11. A sorting device for piece goods, the sorting device comprising:
a plurality of sorting cart elements each having at least one sorting element for receiving and dispensing the piece goods; and
at least one connecting cart element being free of sorting elements;
said sorting cart elements and said at least one connecting cart element forming a closed chain.

12. The sorting device according to claim 11, wherein said at least one connecting cart element and said sorting cart elements each have a respective chassis, and said chassis are identically constructed.

13. The sorting device according to claim 11, wherein said at least one connecting cart element has a top and at least one cover covering said top.

14. The sorting device according to claim 13, wherein said at least one cover and said sorting elements have equal widths.

15. The sorting device according to claim 13, wherein said at least one cover and said sorting elements have upper edges at the same height.

16. The sorting device according to claim 13, wherein:
said at least one cover has a surface;
said sorting elements have receiving surfaces for receiving piece goods; and
said receiving surfaces of said sorting elements and said surface of said at least one cover run substantially in a common receiving plane.

17. The sorting device according to claim 11, wherein said sorting elements each have at least one transverse conveyor belt or a tilt tray.

18. The sorting device according to claim 11, wherein said at least one connecting cart element is a plurality of connecting cart elements.

19. The sorting device according to claim 18, wherein said connecting cart elements and said sorting cart elements are alternatingly disposed in said closed chain.

20. The sorting device according to claim 11, which further comprises:
a track;
said at least one connecting cart element and said sorting cart elements each having two respective wheels and an axle interconnecting said wheels; and
said wheels being configured to be disposed on said track.
